(19) United States
(12) Patent Application Publication
(10) Pub. No.: US 2011/0309645 A1
(43) Pub. Date: Dec. 22, 2011

(54) FLEXIBLE PET WASTE COLLECTION DEVICE, KIT CONTAINING SAME AND THE USE THEREOF

(76) Inventor: Kurt Gans BRISCOE, South Orange, NJ (US)

(21) Appl. No.: 12/845,124

(22) Filed: Jul. 28, 2010

Related U.S. Application Data
(60) Provisional application No. 61/356,714, filed on Jun. 21, 2010.

(51) Int. Cl. A01K 29/00

(52) U.S. Cl. 294/1.3

(57) ABSTRACT

A device aiding the collection of animal waste, flexibly in a large variety of bags readily available to the user, has a frame defining an opening through which an animal waste disposal bag can be fed and against which the mouth of the bag can be held open; a scoop member attached to and extending forward of the frame and cooperating with the opening, so that animal waste scooped up into the scoop member can be manipulated through the opening into the mouth of the bag held open against the frame; a handle attached to or integrated into the frame; and at least one bag position holder attached to or integrated into the frame at a position opposing the position on the frame at which the handle is attached or integrated. A kit containing the device and a method of using the device to collect animal waste are also disclosed.

### PRIORITY CLAIM

This application claims priority of U.S. Provisional Application No. 61/356,714, filed Jun. 21, 2010.

### BACKGROUND OF THE INVENTION

1. Field of the Invention

The present invention relates to the field of pet waste collection and, more particularly, to devices used for such purpose.

2. Description of Related Art

Many municipalities have enacted so-called “pooper scooper” laws requiring a pet owner to clean up after his or her pet defecates on public streets. Accordingly, there are many devices on the market designed to recover such animal wastes. Many of these devices are complicated to use or bulky, which discourages their use. Examples of such devices are those of U.S. Pat. No. Des. 368,003 and U.S. Pat. No. 7,448,659.

Other devices make use of specially adapted disposable bags. The bag is mounted on the device in some fashion, the pet owner manipulates the device to maneuver the animal waste into the bag and then the pet owner releases the bag from the device in some manner and disposes of the bag containing the animal waste. Examples of such devices are those of U.S. Pat. No. 4,718,707 and U.S. Pat. No. 6,086,123.

From the standpoint of environmental friendliness, some of these devices incorporate or make use of biodegradable bags. However, these biodegradable bags must be specially adapted to work in the device. On the other hand, there are a number of brands of unadapted biodegradable waste disposal bags on the market, which, because they have not been adapted to work in prior art devices, cannot be used therein.

For example, the device of U.S. Pat. No. 4,718,707 is sold under the trademark DISPOZ-A-SCOOP™ and has a metal frame against which a specially adapted bag is permanently fixed and held open. The user maneuvers the metal frame with the aid of a holder attached thereto to pick up pet waste, then the holder is collapsed along the metal frame to close the bag. A disadvantage of this system is that the user must use the specially adapted bag. Another disadvantage is that while the bag may be biodegradable, the metal frame is not.

The commercially available KWIK PIK™ Scooper by Four Paws® Products Limited has a handled frame that is part metal and part plastic and designed to hold open a specially adapted flapped bag. The user holds the device by the handle and maneuvers the open bag under the defecating pet and catches the falling waste in the bag. Once this is done, the user closes the flap to seal the bag, which is then disposed of in a waste receptacle. A disadvantage of this system is, again, the need for specially adapted waste collection bags. Also, loading the bag is somewhat complicated and, therefore, again discourages its use.

Another problem with some of these devices is that they do not remain out of contact with the animal waste when it is being collected and, thus, these devices may become soiled with animal waste and need to be cleaned afterwards, which can be a nuisance.

A system that avoids this problem is the commercially available SKOOP-N-PAK™ sold by Pet Zone Products, Limited. The device is a hinged set of jaws, which can be opened on one end if the user pinches together the two jaws at the opposite end. A specially adapted bag is fed through the device to the end that can be opened, and then wrapped around the circumference of each jaw. The user then manipulates the open jaw over the pet waste and releases the pinch, thereby closing the open jaws, capturing the waste in the bag. Because the bag covers the open jaws, the waste cannot contact either jaw during capture, with the result that the device itself never contacts the waste. A disadvantage of this system is, once again, the need to use a specially adapted waste collection bag. Moreover, pinching the jaws open requires significant force, which can make using the device difficult for the elderly or infirm.

Also, many pet owners do not use any animal waste-collecting device at all. Some collect the animal waste in biodegradable bags manually. Others collect the animal waste in other types of bags, for example, plastic bags obtained from grocery stores and the like. A common way of using such bags alone is for the pet owner to place his or her hand inside the bag, grasp the animal waste with the bagged hand, and then turn the bag inside out to contain the animal waste inside the bag. The bag is then tied in a knot at the open end to seal the animal waste inside the bag. The pet owner then simply disposes of the bag containing the waste. A problem with this type of animal waste collection is that many practitioners find the handling of animal waste to be disgusting and repulsive. Even if their hands do not directly touch the animal waste because the bag remains between the animal waste and the practitioner's hand, they are able to feel the consistency of the animal waste through the bag and they understand that they are gripping animal waste. Yet, these practitioner's persist in this practice, many because there is no easy, less disgusting alternative available.

A device designed to make use of a variety of different bags, including grocery bags, to aid in scooping up animal waste is disclosed in U.S. Pat. No. 7,188,878. The device is intended for use mainly with so-called “T-shirt” grocery bags, and, in the main embodiments, has a movable clamp positioned on a telescoping handle. The movable clamp can be manipulated to grasp the handles of the bag, and then moved as needed to tension the remainder of the bag against a frame adapted to hold the mouth of the tensioned bag open while animal waste is scooped inside. The telescoping handle means that the device is intended to be used when the user is standing upright, which makes manipulating the device to maneuver the animal waste inside the bag more difficult. Also, the clamping system makes securing smaller-sized bags challenging. In an alternative embodiment, the clamping system is replaced with hooks located on the bottom and top of the frame portions of the device. The bottom hook is located in a position where it may come in contact with the ground or even residual animal waste on the ground during animal waste pick-up. Accordingly, at least in this alternative embodiment, the entire device does not remain safely covered by the animal waste disposal bag during the animal waste pick-up process, which is disadvantageous.

Accordingly, there remains a need in the art to provide a simple device by which animal waste can be easily collected without soiling the device itself, without the need for the pet owner to handle the animal waste, and yet which also affords the pet owner flexibility to use any of a large variety of collection bags of his or her choosing, without the collection bags needing to be specially adapted in any way to be useful in the device.

### SUMMARY OF THE INVENTION

These and other objects were met with the present invention, which relates in a first embodiment to a device to aid in scooping animal waste into an animal waste disposal bag, said device comprising:
a) a frame defining an opening through which an animal waste disposal bag can be fed and against which the mouth of said animal waste disposal bag can be held open while said animal waste is being scooped into said animal waste disposal bag, said frame having a top, a bottom and two sides;
b) a scoop member attached to and extending forward of said frame and cooperating with said opening, so that animal waste scooped up into said scoop member can be manipulated through said opening into said mouth of said animal waste disposal bag held open against said frame;
c) a handle attached to or integrated into said frame; and
d) at least one animal waste disposal bag position holder attached to or integrated into said frame, said at least one animal waste disposal bag position holder being attached to or integrated into the frame at a position opposing the position on the frame at which said handle is attached or integrated.

The present invention relates in a second embodiment to a kit for scooping up animal waste lying on the ground, said kit comprising:
a) a device described hereinabove and below; and
b) one or more biodegradable animal waste disposal bags.

The present invention relates in a third embodiment to a method of scooping up animal waste lying on the ground, said method comprising:
a) providing a device as described hereinabove and below;
b) providing an animal waste disposal bag;
c) feeding the mouth of the animal waste disposal bag through said opening in said frame and around said scoop member;
d) fastening at least a portion of said animal waste disposal bag in said at least one animal waste disposal bag position holder attached to or integrated into the frame at a position opposing the position on the frame at which said handle is attached or integrated;
e) opening the mouth of said animal waste disposal bag against said frame, so that the mouth of said animal waste disposal bag remains open and covers the scoop member and portions of the frame that would otherwise come in contact with either the animal waste or the ground during step f);
f) scooping up animal waste lying on the ground onto said scoop member;
g) manipulating the animal waste on said scoop member through said opening in the frame into the open mouth of said animal waste disposal bag; and
h) releasing the portion of said animal waste disposal bag fastened in said at least one animal waste disposal bag position holder.

### BRIEF DESCRIPTION OF THE DRAWINGS

The present invention will now be described in greater detail with reference to the drawings, wherein:

FIG. 1 shows one embodiment of a device according to the present invention;

FIG. 2 shows the device of FIG. 1 being fitted with a bag;

FIG. 3 shows the device of FIG. 1 fitted with a bag being maneuvered to capture pet waste;

FIG. 4 shows the device of FIG. 1 fitted with a bag and the captured pet waste retained in the bag;

FIG. 5 shows the bag containing the captured pet waste being removed from the device of FIG. 1;

FIG. 6 shows an elevated rear edge of the device of FIG. 1 fitted with a slit;

FIG. 7A shows a holed slit end and FIG. 7B a waste collection bag fitted with a ball and adapted to cooperate with said holed slit end;

FIG. 8 shows an elevated rear edge of the device of FIG. 1 fitted with a clamp;

FIG. 9 shows an elevated rear edge of the device of FIG. 1 fitted with a hook;

FIG. 10 shows the device of FIG. 1 fitted with a light;

FIG. 11 shows a leash accessory for removable attachment of the device to the handle of a leash;

FIG. 12 shows a rear edge of the device from a top view containing a “cup” or receptacle for holding a knotted waste collection bag containing pet waste during transport; and

FIG. 13 shows the receptacle of FIG. 12 in perspective.

### DETAILED DESCRIPTION OF THE INVENTION

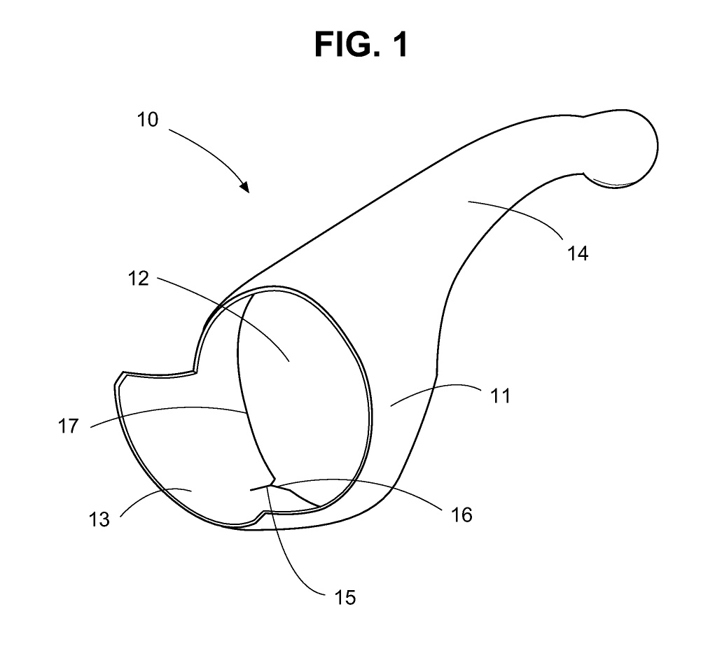

Referring to FIG. 1, device 10 comprises a frame 11, which defines an opening 12. Frame 11 is connected to scoop member 13 at the bottom and to handle 14 at the top. Bottom rear edge 17 is interrupted by slit 15, which has a widened area 16 at the intersection with rear edge 17.

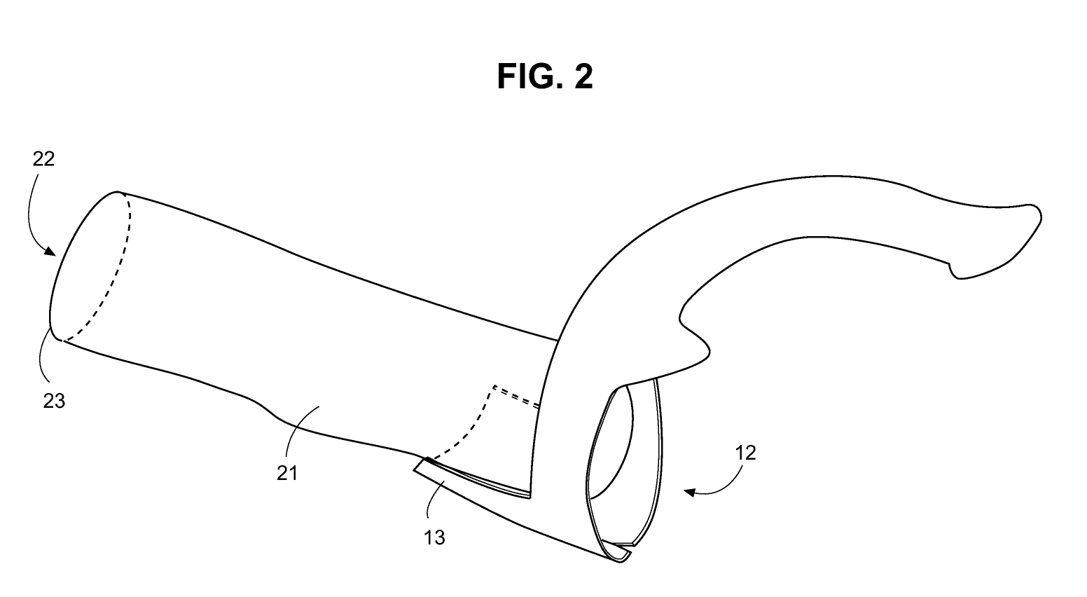

As shown FIG. 2, waste collection bag 21 is fed bag bottom first over scoop member 13 through opening 12 so that the bag rim 23 and the bag opening 22 defined thereby remain outside of opening 12.

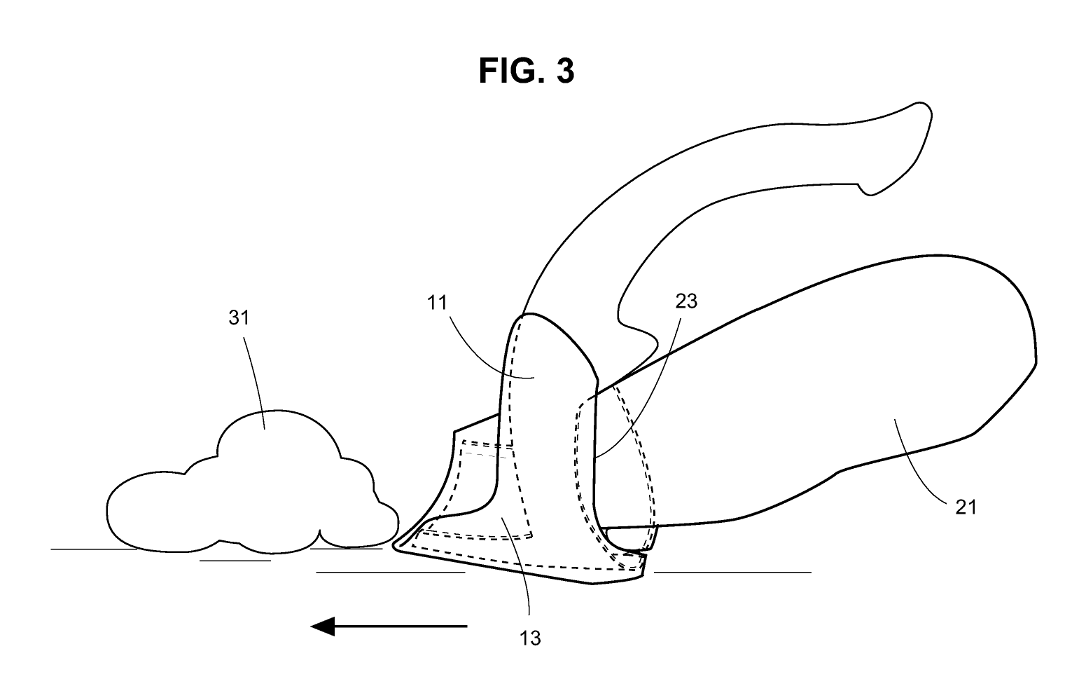

As shown in FIG. 3, once most of bag 21 has been fed through opening 12, the bag 21 is opened around frame 11 and scoop member 13 so that the bag rim 23 actually comes to rest on the rear side of the frame, thereby covering the portions of the frame and the scoop member that might otherwise have come into contact with pet waste 31 or the ground during the waste collection process. At the same time, a portion of bag 21 is fed into slit 15 via widened area 16, and is retained therein and held in place during the collection operation. With the device dressed in this fashion, the waste is now ready to be collected.

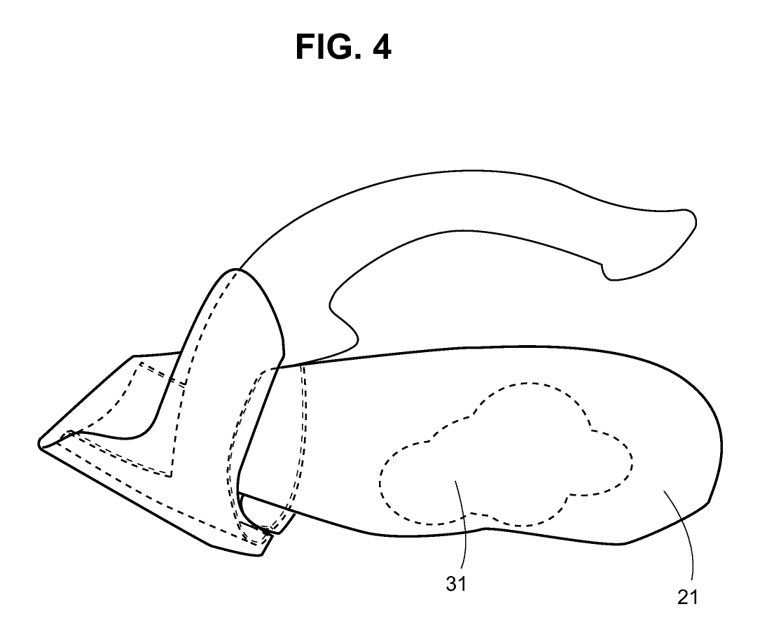

The device 10 fitted with bag 21 is maneuvered in the direction of the arrow in FIG. 3 so that scoop member 13, protected by the covering portions of bag 21, engages and scoops pet waste 31 into the interior of bag 21. FIG. 4 shows pet waste 31 contained in the interior of bag 21.

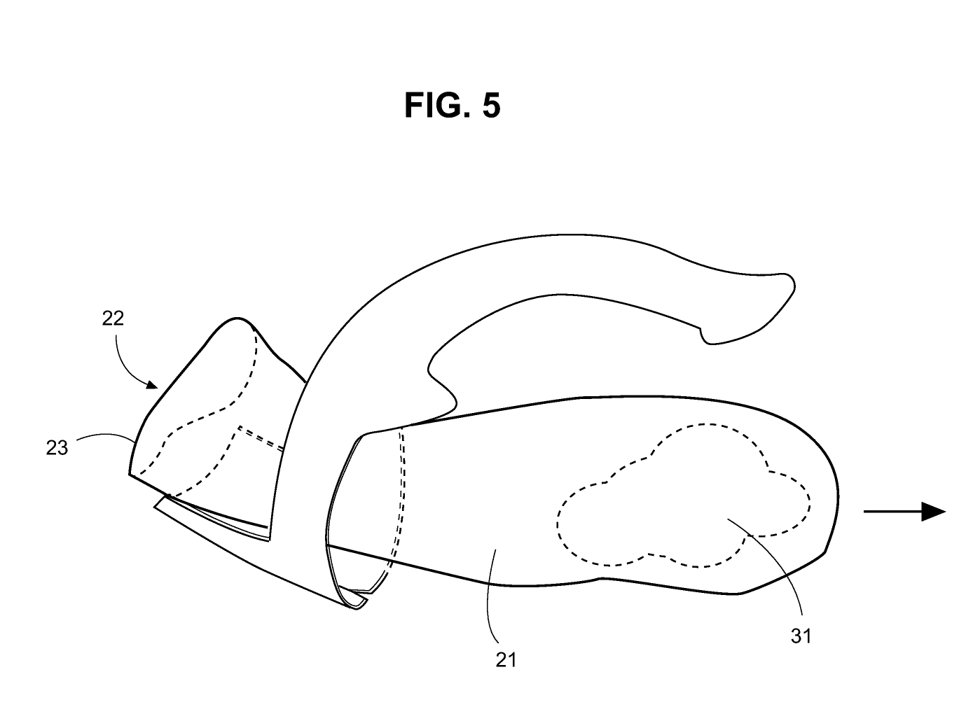

Once the pet waste 31 has been captured in the interior of bag 21, as shown in FIG. 5, the bag can be removed from the device 10 by grasping the bag at rim 23, uncovering it from frame 11 and pulling the bag in the direction of the arrow. Since bag rim 23 was folded about the rear of the frame 11 during the collection of pet waste 31, bag rim 23 will never come in contact with pet waste 31 and, therefore, grasping bag rim 23 at this time is sanitary.

A significant advantage of the device according to the present invention is that it permits the use of all types of bags, biodegradable, as well as plastic grocery store bags. Further, it is not necessary that the bags be adapted in any special way in order to work in the inventive device. Any bag having an opening with a circumference greater than the circumference of the opening 12 should be capable of being fitted to the inventive device and, therefore, useable with the aid of the inventive device to collect pet waste.

In an especially preferred embodiment, use is made of biodegradable bags, and the present invention pertains in an especially preferred embodiment to a kit containing the inventive device, and one or more biodegradable bags.

The device can be made of any suitable material, but is, preferably, injection molded plastic. In an especially preferred embodiment, the entire frame, scoop member, handle and animal waste disposal bag position holder(s) are made from a single injection molded plastic piece.

The frame can have any desired shape, but is preferably circular or oval in shape.

The scoop member can be any desired length and any desired shape. While in the embodiments described above the scoop member extends forward of the frame, the scoop member can also be recessed in the frame as in U.S. Pat. No. 7,188,878, the pertinent features of which are incorporated herein by reference. In an especially preferred embodiment, the scoop member is concave in cross-section. In another especially preferred embodiment, the scoop member is at an angle greater than 0° relative to an adjoining portion of the frame, more preferably angled between 5° and 45°, most preferably between 15° and 30°.

The handle can be integral with the device, as indicated above, or can be a separate component attachable to the frame when desired. In one preferred embodiment, the handle is of a length permitting a user of average height (5 feet, 9 inches) to stand while manipulating the device to scoop up animal waste lying on the ground into the animal waste disposal bag. In another preferred embodiment, the handle is of a length that a user of average height (5 feet, 9 inches) must kneel or bend over in order to manipulate the device to scoop up animal waste lying on the ground into the animal waste disposal bag.

The animal waste disposal bag position holder serves to hold the bag in position against the frame when animal waste is deposited in the interior of the bag. It was discovered that the weight of the incoming waste caused the bag to fall from the device to the ground unless the bag were held to the frame with sufficient force. In the embodiment where the bag is opened against a handle on the top of the frame, the user's fingers can actually hold the top of the open bag in place during the waste collection. In this embodiment, therefore, there is need only of at least one animal waste disposal bag position holder on a bottom of the device, which, in this embodiment, is the position that opposes the top-positioned handle. In the event that the handle connects the frame at the bottom of the frame, then the situation is reversed, and the counterbalancing may be required at the top of the frame, and the at least one animal waste disposal bag position holder should, therefore, be positioned on the top and/or sides of the frame.

In an especially preferred embodiment, the handle is attached to the top of the frame, and the at least one animal waste disposal bag position holder is positioned on the bottom rear of the frame, i.e., on the side of the frame bottom that opposes the scoop member.

Each animal waste disposal bag position holder can be any suitable mechanism that retains a portion, but not the entire bag in place. Thus, each mechanism can be a slit, a clamp, a hook, or any other like device, but is not, for example, a mechanism such as that described in U.S. Pat. No. 3,754,785, which is designed to tension the entire interior bag circumference simultaneously against the frame therein. The device described in U.S. Pat. No. 3,754,785 leaves the entire frame uncovered during waste collection, which means this device suffers the disadvantage discussed previously that the device will come in contact with animal waste during waste collection, necessitating that the device itself be cleaned after every waste collection process. The present invention avoids this disadvantage.

Alternatively, the device can be configured so that the user does not have to use his or her fingers to counterbalance the animal waste disposal bag in the event that the handle is at the top or bottom of the frame. In either case, additional animal waste disposal bag position holders can be positioned at the top of the frame or on the side of the frame, in case the handle is at the top of the frame, or at the bottom of the frame or on the side of the frame, in case the handle is at the bottom of the frame.

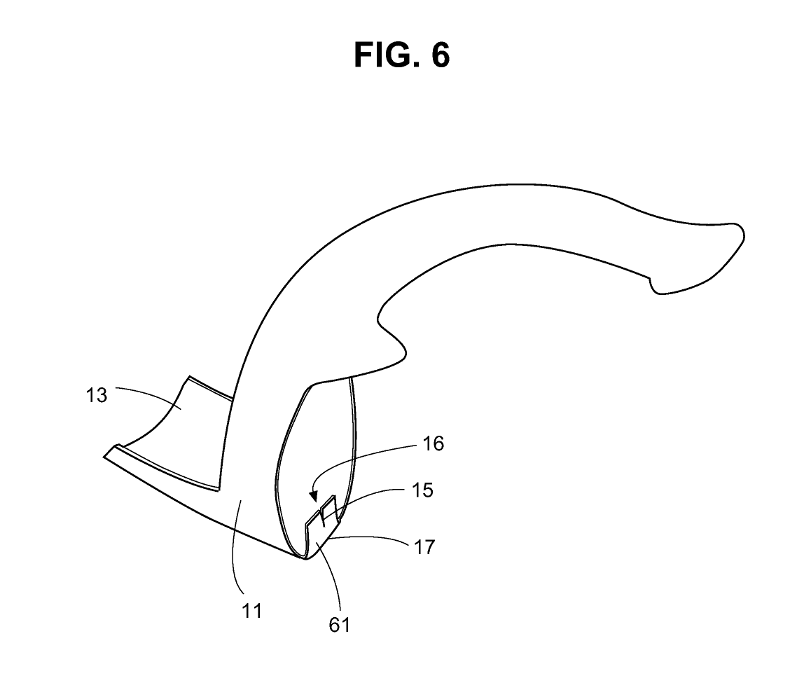

In a preferred embodiment, as shown in FIG. 6, the animal waste disposal bag position holder, in the figure exemplified as a slit, is contained in an elevated rear 61. Elevating the rear has the advantage, as should be apparent, of keeping the portion of the bag rim held on the bottom of the device from contacting the ground while waste is being recovered. Consequently, when the bag is later removed from the device, the user's hand contacting the bag rim should not, thereby, also come in contact either with dirt or waste remnant picked up from the ground during scooping the waste into the bag. The elevated portion has an angle greater than 0° relative to the adjoining portion of the frame. In a preferred embodiment, the angle is between 15° and 180°. In an especially preferred embodiment, the angle is between 45° and 135°.

As shown in the drawings, the bottom of the frame and the scoop member 13 are slightly curved over the course of their length in the direction from the front of the device through opening 12 to the back of the device. This curvature can be taken into account in designing the elevated portion mentioned above, with a more severe curvature of these components being used, if desired, to ensure that when scoop member 13 is being used to scoop waste, the elevated portion is already clear of the ground. In that case, the adjoining portion of the frame could be part of a curve, and the angle measured relative to a tangent of a point on that curve.

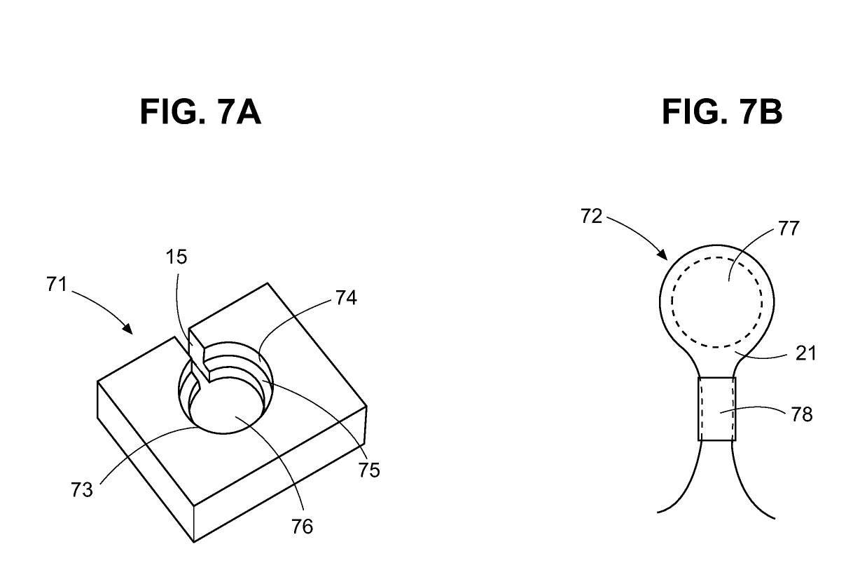

Referring to FIGS. 7A and 7B, instead of a slit, preferably the animal waste disposal bag position holder can be configured as a retainer 71 for a balled bag 72. The ball retainer 71 comprises a slit 15, through which the balled bag 72 can be fed, and a holed end 73 at the closed end of the slit 15 for retaining the balled bag 72. The holed end 73 further comprises a retaining wall 74, a ball shelf 75 and a ball retainer opening 76, which cooperate to form a seating for accepting and retaining the balled bag 72. The balled bag 72, in turn, comprises bag 21 adapted to cover on an end thereof a ball 77, which is maintained inside the bag 21 by collar 78. In use, the balled bag 72 will be fed through slit 15 and seated inside ball retainer 71 where the balled bag will be held securely throughout the waste collection process. The slit 15 and holed end 73 are preferably contained in an elevated rear, but containing in a flat rear is also possible.

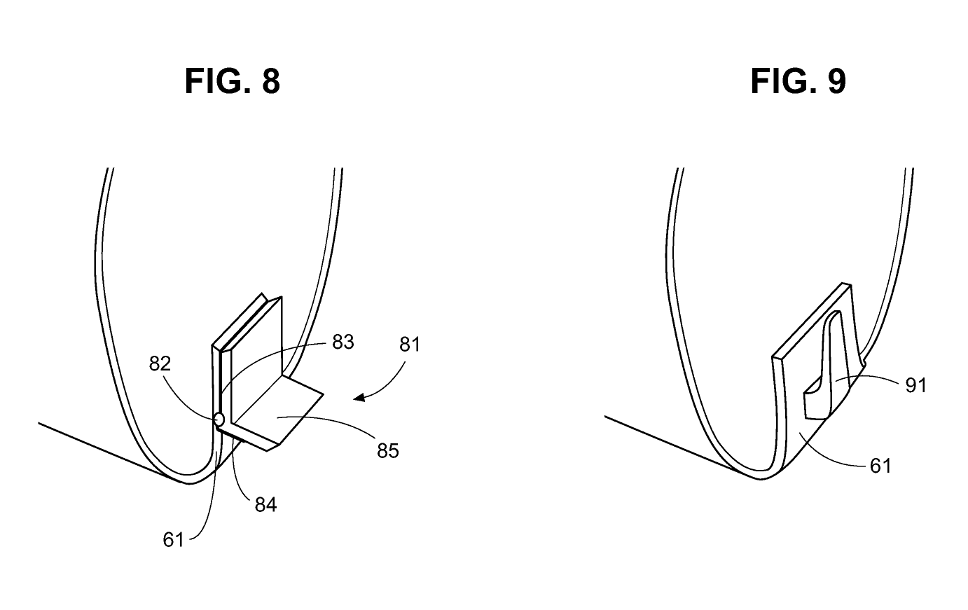

In another preferred embodiment, which is shown in FIG. 8, the animal waste disposal bag position holder can be configured as a clamp 81, for purposes of this depiction only adapted to elevated rear 61. (The clamp 81 can likewise be adapted to a flat rear, not shown.) The clamp 81 comprises a spring coil 82 having spring ends 83 and 84 operably connected to movable clamp arm 85. In use, the movable clamp arm 85 is manipulated to capture a portion of waste collection bag 21 in the clamp 81 where it is held securely during the waste collection process.

In another preferred embodiment, which is shown in FIG. 9, the animal waste disposal bag position holder can be configured as a hook 91, again, for the purposes of this depiction only adapted to elevated rear 61. (The hook 91 can likewise be adapted to a flat rear, not shown.) In use, a portion of the waste collection bag 21 is hooked on hook 91 where it is held securely during the waste collection process.

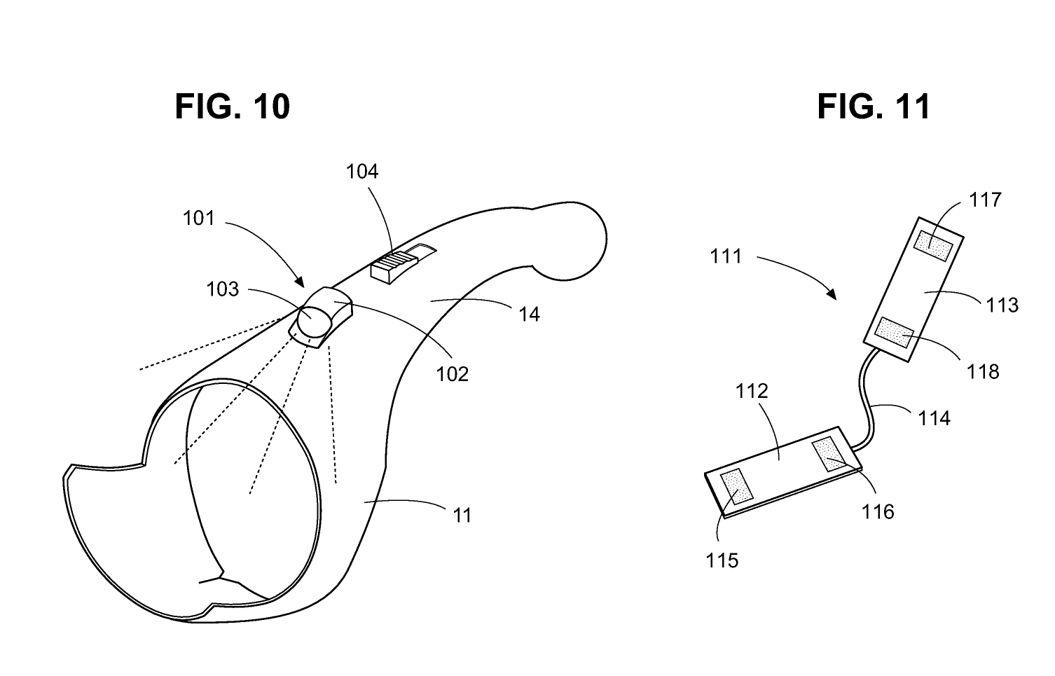

Referring to FIG. 10, in a preferred embodiment, the frame 11 is equipped with an integrated light fixture 101, allowing illumination of the waste area at night, which is very advantageous as many pet owners walk their pets during nighttime hours. The light fixture 101 comprises a hood 102, which directs light rays emitted by bulb 103 away from the users eyes and onto the waste area. The light is controlled by switch 104.

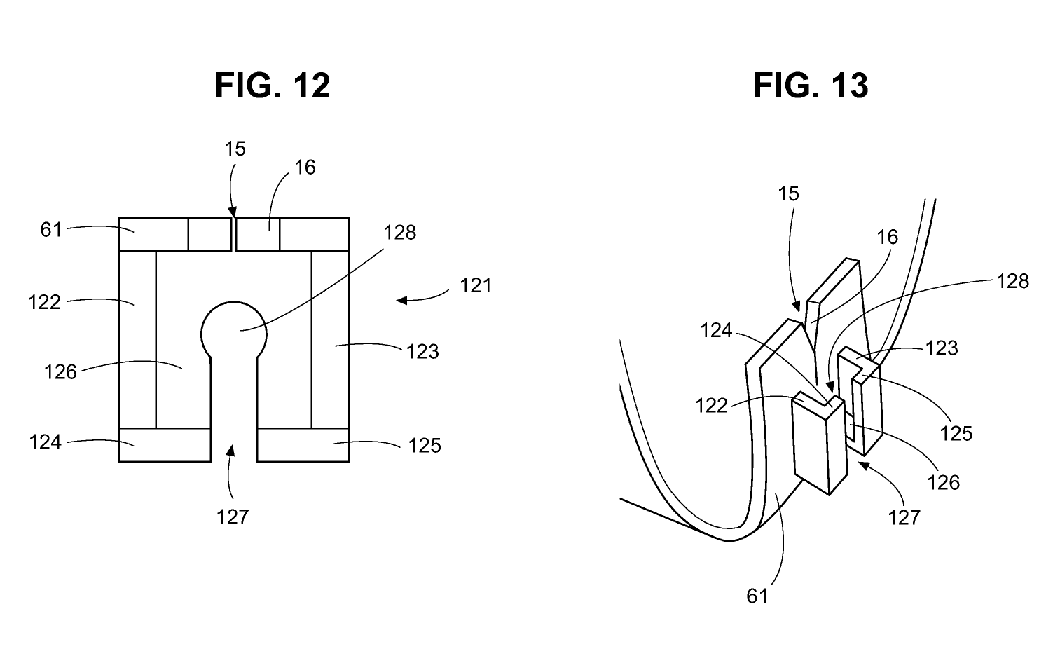

Referring to FIGS. 11 and 12, preferred embodiments are depicted for transporting the device with and without collected waste. FIG. 11 depicts a leash accessory 111 for use with the device that permits the device to be attached to a pet leash. The leash accessory 111 comprises wrappers 112 and 113, which are preferably made of some type of fabric, and are connected by connector 114, which is made of string, leather, chain or any other suitable material. Each of wrappers 112 and 113 comprises a pair of mating fasteners 115 and 116, in the case of wrapper 112, and 117 and 118, in the case of wrapper 113, which permits one of the wrappers 112 or 113 to be removably wrapped about the device and the other of wrappers 112 or 113 to be wrapped around the handle of a leash. The fasteners can be any suitable type, but are preferably VELCRO™ (hook and loop mating fasteners). Use of the device shown in FIG. 11 permits easy transportation of the device to and from the waste collection area.

In a like manner, the device can also be fitted with a clip, not shown, on the handle 14, which allows the device to be clipped to the belt or pants of the user. Alternatively, the handle itself may be formed on the distal end in the shape of a hook affording the same advantage.

As shown in FIGS. 12 and 13, elevated rear 61, for purposes of this depiction only fitted with a slit 15 having widened area 16, can be adapted with knotted bag transport receptacle 121, which comprises a series of extension arms 122 and 123, each terminating in retaining walls 124 and 125, respectively, collectively cupping and retaining knotted bag retaining bottom 126. In use, once pet waste 31 is collected in waste collection bag 21 and the bag 21 is removed from the device, the pet waste 31 is sealed inside the bag 21 by tying a knot in the open end of the bag 21. This knotted bag is easily transported by the transport receptacle 121 by sliding the knotted bag through channel 127 and seating the knot in knot recess 128. Thus, when both the leash accessory 111 shown in FIG. 11 and the transport receptacle shown in FIG. 12 are used, the device can carry the knotted bag by the transport receptacle 121, and device carrying the knotted bag can be attached to the leash by the leash accessory 111.

While the present invention has been described in conjunction with the specific embodiments set forth above, many alternatives, modifications and other variations thereof will be apparent to those of ordinary skill in the art. All such alternatives, modifications and variations are intended to fall within the spirit and scope of the present invention.

1. A device to aid in scooping animal waste into an animal waste disposal bag, said device comprising an injection-molded plastic piece having the following distinct components:
a) a frame having a front, a back, a top, a bottom and two sides, and being open on the front and the back to define an opening through which an animal waste disposal bag can be fed, the frame being adapted so that the mouth of said animal waste disposal bag fed through said opening can be held open against said frame while said animal waste is being scooped into said animal waste disposal bag;
b) a scoop member extending forward of said bottom of said frame and cooperating with said opening, so that animal waste scooped up onto said scoop member can be manipulated through said opening into said mouth of said animal waste disposal bag held open against said frame;
c) a handle joining said top of said frame, said handle being of a length that a user of average height must kneel or bend over in order to manipulate the device to scoop up animal waste lying on the ground into the animal waste disposal bag; and
d) at least one slit opening along a bottom back edge of said frame through which a portion of the animal waste disposal bag can be fed and held firmly in place while the device is being manipulated to scoop up animal waste lying on the ground into the animal waste disposal bag.

2. The device according to claim 1, wherein the frame is a complete circle or oval in shape.

3. The device according to claim 1, wherein the scoop member is concave in cross-section.

4. The device according to claim 1, wherein the slit is widened at an exterior, accessible end of the slit in order to ease feeding into the slit of that portion of the animal waste disposal bag to be held in the slit.

5. The device according to claim 1, wherein the slit is contained in a portion of the bottom of the frame that is at an angle greater than 0° relative to an adjoining portion of the bottom of said frame.

6. The device according to claim 5, wherein the angle is between 15° and 180°.

7. The device according to claim 6, wherein the angle is between 45° and 135°.

8. The device according to claim 1, which comprises at least one member selected from the group consisting of a slit, a holed slit, a hook and a clamp on a top portion of said frame or on the handle.

9. The device according to claim 8, which comprises at least one hook on said top portion of said frame over which a top portion of said animal waste disposal bag can be hooked.

10. The device according to claim 1, which comprises a light fixture integrated into said frame.

11. The device according to claim 1, which comprises on a bottom of said frame a receptacle adapted to receive and hold for transportation an animal waste disposal bag closed on a previously open end by forming a knot in said animal waste disposal bag that closes said previously open end.

12. A kit for scooping up animal waste lying on the ground, said kit comprising:
a) a device according to claim 1; and
b) one or more biodegradable animal waste disposal bags.

13. A method of scooping up animal waste lying on the ground, said method comprising:
a) providing a device according to claim 1;
b) providing an animal waste disposal bag;
c) feeding the mouth of the animal waste disposal bag through said opening in said frame and around said scoop member;
d) fastening at least a portion of said animal waste disposal bag in said at least one slit opening along a bottom back edge of said frame;
e) opening the mouth of said animal waste disposal bag against said frame, so that the mouth of said animal waste disposal bag remains open and covers the scoop member and portions of the frame that would otherwise come in contact with either the animal waste or the ground during step f);
f) scooping up animal waste lying on the ground onto said scoop member;
g) manipulating the animal waste on said scoop member through said opening in the frame into the open mouth of said animal waste disposal bag; and
h) releasing the portion of said animal waste disposal bag fastened in said at least one slit.

14. The method according to claim 13, wherein during steps f)-h), a top portion of the open mouth of said animal waste disposal bag is held open against the handle of said device by the hand of a user of the device grasping a portion of the handle against which the top portion of the open mouth of said animal waste disposal bag rests.

15. The method according to claim 13, which further comprises before step f), fastening a top portion of said animal waste disposal bag to at least one member selected from the group consisting of a slit, a holed slit, a hook and a clamp on a top portion of said frame or on the handle.

16. A device to aid in scooping animal waste into an animal waste disposal bag, said device comprising an injection-molded plastic piece having the following distinct components:
a) a frame having a front, a back, a top, a bottom and two sides, and being open on the front and the back to define an opening through which an animal waste disposal bag can be fed, the frame being adapted so that the mouth of said animal waste disposal bag fed through said opening can be held open against said frame while said animal waste is being scooped into said animal waste disposal bag;
b) a scoop member extending forward of said bottom of said frame and cooperating with said opening, so that animal waste scooped up onto said scoop member can be manipulated through said opening into said mouth of said animal waste disposal bag held open against said frame;
c) a handle joining said top of said frame, said handle being of a length that a user of average height must kneel or bend over in order to manipulate the device to scoop up animal waste lying on the ground into the animal waste disposal bag;
d) at least one slit opening along a bottom back edge of said frame through which a portion of the animal waste disposal bag can be fed and held firmly in place while the device is being manipulated to scoop up animal waste lying on the ground into the animal waste disposal bag, the slit being widened at an exterior, accessible end of the slit in order to ease feeding into the slit of that portion of the animal waste disposal bag to be held in the slit, and the slit being contained in a portion of the bottom of the frame that is at an angle between 15° and 180° relative to an adjoining portion of the bottom of said frame; and
e) a receptacle on said bottom of said frame, said receptacle adapted to receive and hold for transportation an animal waste disposal bag closed on a previously open end by forming a knot in said animal waste disposal bag that closes said previously open end.
